(19) United States
(12) Patent Application Publication
(10) Pub. No.: US 2013/0016172 A1
(43) Pub. Date: Jan. 17, 2013

(54) THERMAL TRANSFER PRINTER

(71) Applicants: Ichiro Furuki, Tokyo (JP); Shiohiro Okinaka, Tokyo (JP); Tomoyuki Takeshita, Tokyo (JP)

(72) Inventors: Ichiro Furuki, Tokyo (JP); Shiohiro Okinaka, Tokyo (JP); Tomoyuki Takeshita, Tokyo (JP)

(73) Assignee: Mitsubishi Electric Corporation, Chiyoda-ku (JP)

(21) Appl. No.: 13/637,537

(22) PCT Filed: Apr. 9, 2010
(86) PCT No.: PCT/JP10/02615

§ 371 Date: Sep. 26, 2012

(51) Int. Cl. B41J 35/16

(52) U.S. Cl. 347/172

(57) ABSTRACT

In a thermal transfer printer for printing a color picture by dividing it into pieces with a prescribed size, an image data converting unit 10 includes a joint shifting unit 10b for shifting a joint of each color between the divided pieces so that the joints of individual colors are not aligned with each other in the sub-scanning transfer direction, and a joint processing unit 10c for transferring the joints of the individual colors, which are shifted by the joint shifting unit, so that the joints overlap each other, and for correcting gradation data in the overlapping portion according to correction coefficients that are set in advance for each line in the sub-scanning transfer direction.

### TECHNICAL FIELD

The present invention relates to a thermal transfer printer for making a wide print.

### BACKGROUND ART

As for conventional sublimation dye transfer color printers, there are those which employ an ink sheet, on which ink areas of yellow (Y), magenta (M) and cyan (C) colors are applied in the direction of the length, and use rolled paper as recording paper. Such a thermal transfer printer forms a color picture by applying heat on the ink sheet from a thermal head to add printing of the colors onto the same area of the recording paper.

In this case, the image area formed is limited by the ink area. Accordingly, to print a wide image such as a panoramic picture, it is necessary to replace the ink sheet to another ink sheet corresponding to the wide image area, which offers a problem of a troublesome ink change. In addition, long ink sheets used for pictures such as panoramic pictures have a problem in that their distribution is smaller than that of normal size ink sheets, and that they are more expensive. Accordingly, a panoramic picture is made by dividing its wide image, and by printing divided images separately and by combining them.

However, the conventional panoramic picture forming method as described above has a problem of deteriorating image quality at joint sections of the image. Accordingly, Patent Document 1 discloses a method of printing divided images in such a manner as to overlap each other. For example, when an image is divided into two pieces, it prints the image of the first piece and then the image of the second piece in such a manner that their edges overlap each other.

By the way, the sublimation dye transfer printer has a transfer sequence of three color inks Y, M and C. For example, when it forms an image in the order of Y color transfer, M color transfer, and C color transfer, a method described in the Patent Document 1 brings about a case where at overlapping sections of divided images, the Y color of the second piece is transferred upon the C color of the first piece. In this case, since the transfer sequence of the ink colors alters, a problem occurs of changing color tones in joint sections.

Accordingly, Patent Document 2 discloses a method of forming different joints for each color and combining the joints in a comblike fashion, thereby making a print in such a manner that the images do not overlap each other. For example, when an image is divided into two pieces, it prints the end portion of the first piece in a comblike fashion extending to the direction of movement of ink transfer and the start portion of the second piece in a comblike fashion extending to the opposite direction of the transfer so that their comblike sections are placed alternately.

In addition, the method described in the Patent Document 1 can arise a problem of causing a reverse transfer phenomenon at image overlapping sections.

The term “reverse transfer phenomenon” is defined as a phenomenon that causes a first transferred color ink to be somewhat transferred to a second transfer color ink sheet because of the energy applied from the thermal head, thereby reducing the transfer density of that section.

As a method of preventing the transfer density reduction due to the reverse transfer phenomenon, a Patent Document 3 describes processing of correcting image data in sections where the same color ink is transferred repeatedly in such a manner as to increase the energy applied to the section corresponding to the following transfer from the energy applied to the section corresponding to the previous transfer.

### PRIOR ART DOCUMENT

### Patent Document

Patent Document 1: Japanese Patent Laid-Open No. 2004-82610.

Patent Document 2: Japanese Patent Laid-Open No. 2000-85165.

Patent Document 3: Japanese Patent Laid-Open No. 10-58732.

### DISCLOSURE OF THE INVENTION

By the way, a thermal transfer printer has another problem in that the transfer density varies owing to the heat storage temperature of the thermal head. At a start of the image transfer, since the heat storage temperature of the thermal head is low, the transfer density is low. Therefore the transfer method as described in the Patent Document 2, which does not overlap the joints, has a problem in that the transfer density in the start portion of the second piece becomes low, and hence the transfer density in the joints becomes low.

In addition, the methods described in the Patent Document 1 and Patent Document 3 have a problem in that since the transfer sequence of the ink colors alters in the overlapping sections of divided images, the color tone in the joint sections varies.

In addition, a method is easily conceivable which combines the method described in the Patent Document 1 with the method described in the Patent Document 2 to shift the joint position of each color and transfer the same color on that color repeatedly.

In this case, it is found that a problem occurs even if the same color is not transferred on that color repeatedly.

The problem is that the density of a previously transferred color becomes somewhat lower at the joint position shifted within the same image piece.

FIG. 26 is a diagram illustrating the problem of the transfer density reduction at the joint position.

FIG. 26(a) is a plan view showing a transferred state when transferred in the order of Y color, M color and C color, and FIG. 26(b) is a schematic diagram showing a cross sectional state of the ink transfer. The letter E designates the transfer end of the Y color and M color in the sub-scanning direction, and X designates the transfer end of the C color in the sub-scanning direction. The transfer end of the C color in the sub-scanning direction differs from the transfer end of the Y color and M color in the sub-scanning direction. The transfer density of the C color is high, and the transfer density of the Y color and that of the M color are halftone.

FIG. 26(c) shows the transfer density of the Y color component along sub-scanning line position in the transfer state.

The symbol ODav designates the average density of the two-color transfer state of Y color and M color, and ODx designates the Y color component density at the X position. In addition, AOD designates the difference between the Y color component density ODx at the X position and the average density ODav of the two-color transfer of the Y color and M color.

Properly, the Y color component density after completing the C color transfer, that is, that after the X position remains equal to or higher than the ODay. However, it is clearly shown in FIG. 26(c) that the Y color component density drops by DOD at the X position. As a cause of the density reduction, although it is conceivable that one of the reverse transfer phenomena occurs which transfers dye from the ink reception layer of the recording paper to the ink sheet, a clear-cut mechanism in unknown at the present.

Although this problem can occur even in a single image printing that prints image patterns which shift the transfer end of each color in the sub-scanning direction as shown in FIG. 26, since the density reduction is very small and occurs at the boundary between colors in the image patterns, the problem matters little in the single image printing.

However, when transferring the second piece on top of the joint position, since the same color pattern occurs in front and behind the joint of the pieces, a problem arises that a slight density reduction in the joint of the color stands out as a low density line.

In addition, when transferring a color over the existing colors, a technique is generally known which makes joints inconspicuous by controlling in such a manner as to gradually reduce gradation data at the end portion of the first piece of each color and by gradually increasing gradation data at the start portion of the second piece. When transferring the same color over the existing colors while shifting joint positions of each color by using the technique, it is found that another problem arises.

The problem is that the density of an ink color transferred afterward increases at the joint position of an ink color transferred previously.

FIG. 27 is a diagram illustrating the problem of the transfer density increase at the joint position.

FIG. 27(a) is a schematic diagram showing an ink transfer state when transferring on the Y color joint the M color and C color in this order, in which Y1 designates a first piece Y color, Y2 designates a second piece Y color, Yₗₐₚ designates an area where the same Y color ink of the first piece and second piece overlap each other. FIG. 27(b) is a cross sectional view of recording paper showing a surface state of a recording paper reception layer after the Y color transfer. FIG. 27(c) is a diagram showing the gradation data of the Y color, M color and C color, which are controlled in such a manner as to gradually reducing the gradation data 801 of the first piece Y color and gradually increasing the gradation data 802 of the second piece Y color. The gradation data 803 of the M color or C color is set to become lower than the Y color gradation data 801 and 802 and the transfer density of the Y color is set to become high. The transfer density of the M color or C color is set to become halftone.

FIG. 27(d) shows in this transfer state the transfer density of the Y color component, M color component and C color component along the sub-scanning line position. FIG. 27(d) shows the Y color component density 804, M color component density 805, and C color component density 806 as the transfer density of each color.

The symbol ΔODm designates the M color component density difference between the M color component density in front and behind the Y color joint and the M color component density in the Yₗₐₚ interval, and ΔODc designates the C color component density difference between the C color component density in front and behind the Y color joint and the C color component density in the Yₗₐₚ interval.

The Y color component density in the Yₗₐₚ interval is nearly equal to the density in front and behind the Yₗₐₚ interval, which means that the Y color joint is in a good state. On the other hand, although the M color and C color component density in the Yₗₐₚ interval is expected to be equal to the density in front that the M color component density and C color component density increase by the amount ΔODm and ΔODc in the Yₗₐₚ interval.

The density increase is considered to come from the surface state of the recording paper reception layer after the Y color transfer which is made previously as shown in FIG. 27(b). To transfer high gradation data, the thermal transfer print system has to increase the energy applied to the thermal head to raise the transfer density, in which case the recording paper reception layer can suffer thermal damage (reception layer becomes nearly burnt state). FIG. 27(b) shows the state in which the surface state 806 after the Y color transfer of the first piece and the surface state 807 after the Y color transfer of the second piece have a rough recording paper reception layer (the surface is uneven) because of the high gradation Y color data. In contrast with this, in the Yₗₐₚ interval, since the thermal energy is applied in such a manner that the gradation data 801 of the first piece Y color is gradually reduced and the gradation data 802 of the second piece Y color is gradually increased as shown in FIG. 27(c), the thermal energy applied to the recording paper reception layer is reduced in the Yₗₐₚ interval. Accordingly, the recording paper reception layer surface 808 in the Yₗₐₚ interval is expected to be more smooth (less uneven) as compared with the surface state 806 after the first piece Y color transfer or the surface state 807 after the second piece Y color transfer. Actually, the inventors measured the recording paper reception layer state with a laser microscope (Keyence VK8700) and confirmed that the recording paper reception layer surface 808 in the Yₗₐₚ interval was smoother (lower in the surface roughness measurement Ra) than the surface state 806 of the first piece after the Y color transfer or the surface state 807 of the second piece after the Y color transfer.

In the thermal transfer print system, the ink transfer quality becomes better as the contact between the thermal head and the recording paper reception layer becomes closer. Accordingly, when transferring constant gradation image data such as the M color or C color as shown in FIG. 27(c), if the recording paper reception layer is in the state as shown in FIG. 27(b), the recording paper reception layer is expected to achieve higher density transfer in a smoother portion. Although more detailed mechanism about the problem is unknown at the present, it is true that an excessive transfer problem occurs in that the density of an ink color transferred afterward increases in the joint position of the ink color transferred previously. The excessive transfer can cause a black line which will deteriorate the printing quality.

The present invention is implemented to solve the foregoing problems. Therefore it is an object of the present invention to provide a thermal transfer printer capable of making joints between pieces of an image more inconspicuous when making a print wider than a prescribed size by printing, after printing a piece with the prescribed size, the next piece adjacently to it.

A thermal transfer printer in accordance with the present invention comprises: a joint shifting unit for shifting a joint of each color between divided pieces so that joints of individual colors are not aligned with each other in a sub-scanning transfer direction; and a joint processing unit for transferring the joints of the individual colors, which are shifted by the joint shifting unit, so that the joints overlap each other, and for correcting gradation data in the overlapping portion according to correction coefficients that are set in advance for each line in the sub-scanning transfer direction.

According to the present invention, since it shifts the joints of the three colors Y, M and C, transfers the joints of the individual colors so as to overlap each other, and corrects the gradation data of the overlapping portions according to the correcting coefficients set in advance for each line in the sub-scanning transfer direction, it offers an advantage of being able to obtain a wide printing result while making the joints inconspicuous.

### BRIEF DESCRIPTION OF THE DRAWINGS

FIG. 1 is a diagram showing a construction of a printer mechanism in an embodiment 1 in accordance with the present invention;

FIG. 2 is a block diagram showing a system configuration of a thermal transfer printer in the embodiment 1 in accordance with the present invention;

FIG. 3 is a plan view showing a color ink sheet in the embodiment 1 in accordance with the present invention;

FIG. 4 is a flowchart showing conversion process of input image data in the embodiment 1 in accordance with the present invention;

FIG. 5 is a schematic diagram showing an ink transfer state in a joint between pieces of an image in the embodiment 1 in accordance with the present invention;

FIG. 6(a) is a diagram showing an input image and FIGS. 6(b), 6(c) and 6(d) are diagrams illustrating a dividing method of the input image data;

FIG. 7 is a schematic diagram showing the image data with their joints of Y, M and C colors being shifted, in which FIG. 7(a) is a schematic diagram showing a plane and FIG. 7(b) is a side view thereof;

FIG. 8 is a schematic plan view showing the image data with their joints of Y, M and C colors being shifted;

FIG. 9 is a diagram showing relationships between a sub-scanning line number of any given gradation data of a C color and transfer density in a joint;

FIG. 10(a) is a diagram showing a lookup table (LUT) of a C color at the end portion of a first piece, and FIG. 10(b) is a diagram showing an LUT of the C color at the start portion of a second piece;

FIG. 11 is a diagram showing density distribution as a result of transfer to a joint after gradation data conversion;

FIG. 12(a) is a schematic view showing image patterns for illustrating, as to a reverse transfer problem, mutual relation between gradation data of an ink color to be transferred over the existing colors and gradation data of (previously transfer) ink colors expected to form a base, FIG. 12(b) is a schematic plan view showing a state of ink joints in a wide print formed by applying joint processing steps ST1-ST3 to pattern images of three colors Y color, M color and C color, and FIG. 12(c) is a schematic side view of FIG. 12(b);

FIG. 13 is a diagram showing density distribution in the sub-scanning transfer direction (H-H′ direction in FIG. 12(b)) after making a wide print with the gradation data of the C color being made a high density in the patterns of FIG. 12;

FIG. 14 is joint density difference graphs illustrating density difference of Y color component, M color component and C color component along a line position near a C color joint;

FIG. 15 is a schematic diagram showing Y, M and C gradation data after applying a joint processing step to image patterns with a gradation value in the sub-scanning transfer direction being fixed for each color;

FIG. 16 is a schematic diagram showing Y, M and C gradation data after applying reverse transfer correction processing after executing a joint processing step like that of FIG. 15;

FIG. 17 is an LUT for acquiring the maximum gradation value t_{yc}, at the C color joint line position after correcting the Y color;

FIG. 18 is an LUT for acquiring corrections in the correction line interval l_{yc};

FIG. 19 is a schematic diagram showing Y, M and C gradation data after applying a joint processing step to the image patterns in which the gradation value in the sub-scanning transfer direction is fixed for each color;

FIG. 20 is a schematic diagram showing Y, M and C gradation data when applying excessive transfer correction processing after executing a joint processing step like that of FIG. 19;

FIG. 21 is an LUT for acquiring the minimum gradation value t_{cy}′ at a Y color joint line position after correcting the C color;

FIG. 22 is an LUT for acquiring corrections in a correction line interval l_{cy};

FIG. 23 is a flowchart showing the wide printing operation in the embodiment 1 in accordance with the present invention;

FIG. 24 is a plan view showing an ink sheet in an embodiment 2 in accordance with the present invention;

FIG. 25 is a schematic diagram showing an ink transfer state in joints between pieces of an image in the embodiment 2 in accordance with the present invention;

FIG. 26 is a diagram illustrating a problem of a transfer density reduction at a joint position; and

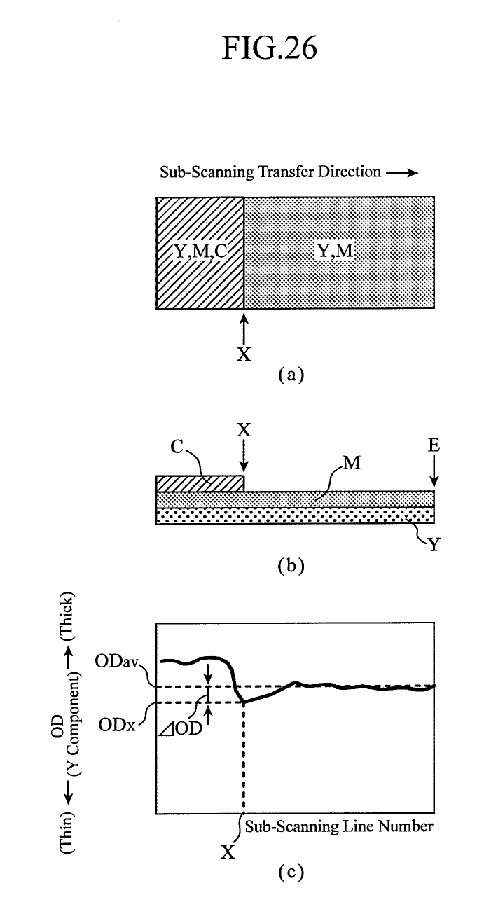

FIG. 27 is a diagram illustrating the problem of a transfer density increase at a joint position.

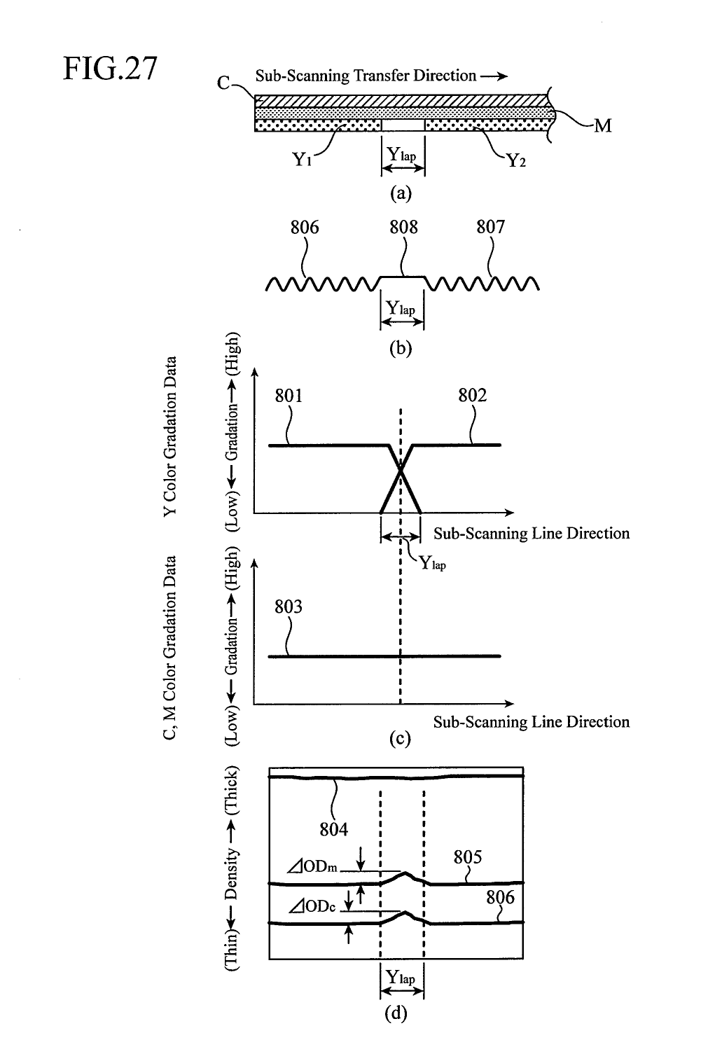

### EMBODIMENTS FOR CARRYING OUT THE INVENTION

The best mode for carrying out the invention will now be described with reference to the accompanying drawings to explain the present invention in more detail.

### Embodiment 1

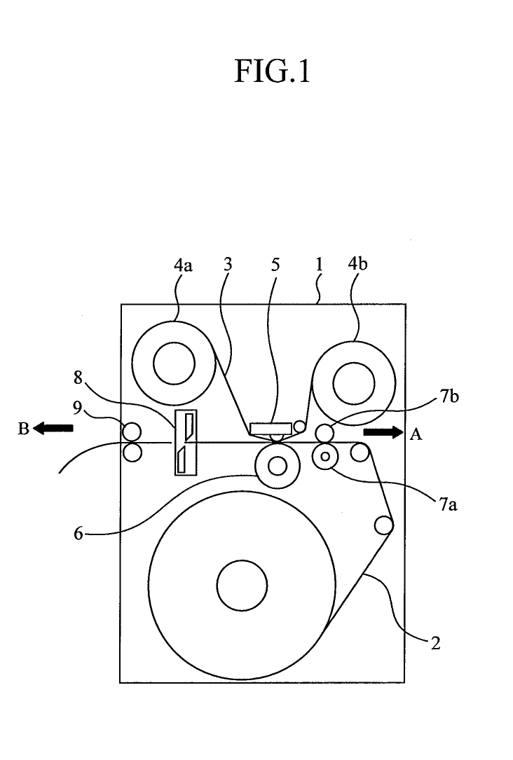

FIG. 1 is a diagram showing a printer mechanism in an embodiment 1 in accordance with the present invention. In FIG. 1, a printer 1 is an image forming apparatus and uses rolled paper 2 as recording paper. The mechanism unit of the printer 1 comprises an ink sheet 3 for three color printing of yellow (Y), magenta (M) and cyan (C), an ink sheet feed reel 4a and an ink sheet take-up reel 4b, a thermal head 5 for causing the ink sheet 3 to record, and a platen roller 6. The thermal head 5 is constructed so as to be pushed to or pulled from the platen roller 6 with a driving unit not shown.

A grip roller 7a conveys the recording paper 2 at a fixed speed, and a pinch roller 7b is disposed against the grip roller 7a. A recording paper cutting mechanism 8 cuts the recording paper 2 after printing, and a paper output roller 9 ejects the cut recording paper 2 to the outside of the printer 1.

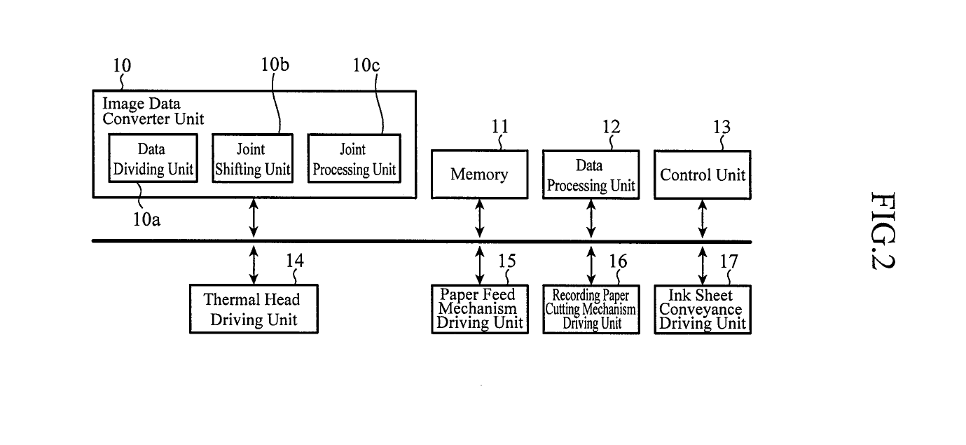

FIG. 2 is a block diagram showing a system configuration of the thermal transfer printer of the embodiment 1. In FIG. 2, an image data converter unit 10 converts wide image data with a size above a prescribed picture size to image data for a thermal transfer print method in accordance with the present invention. In addition, in accordance with its functions, the image data converter unit 10 comprises a data dividing unit 10a, a joint shifting unit 10b and a joint processing unit 10c. Details will be given later in the explanation about the image data conversion by the image data converter unit 10.

A memory 11 stores the image data passing through the conversion by the image data converter unit 10, and a data processing unit 12 converts the image data stored in the memory 11 to print data for the printer.

A thermal head driving unit 14 drives the thermal head 5 in accordance with the print data for the printer supplied from the data processing unit 12. A paper feed mechanism driving unit 15 drives the grip roller 7a and paper output roller 9 for conveyance operation of the recording paper 2.

A recording paper cutting mechanism driving unit 16 drives the recording paper cutting mechanism 8, and an ink sheet conveyance driving unit 17 carries out the conveyance operation of the ink sheet 3. A control unit 13 controls the operation of the image data converter unit 10, memory 11, data processing unit 12, thermal head driving unit 14, paper feed mechanism driving unit 15, recording paper cutting mechanism driving unit 16 and ink sheet conveyance driving unit 17.

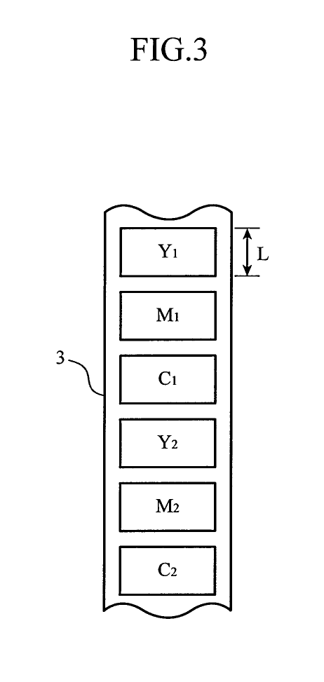

FIG. 3 is a plan view showing the ink sheet 3. The ink sheet 3 includes three color ink areas arranged in order. In FIG. 3, Y₁ and Y₂ designate a yellow ink area, M₁ and M₂ designate a magenta ink area, C₁ and C₂ designate a cyan ink area, and L designate a prescribed picture size in the sub-scanning transfer direction. In addition, Y₁ , M₁ and C₁ designate an ink area of each color of a first piece of an image, and Y₂ M₂ and C₂ designate an ink area of each color of a second piece of the image.

Next, the printing operation of the printer 1 in the embodiment 1 will be described. First, the printing operation of the prescribed picture size will be described.

In a state before printing, the ink sheet 3 is set so as to pass through the gap between the thermal head 5 and platen roller 6, and the recording paper 2 passes through the gap between the color ink sheet 3 and platen roller 6 and is in a state of being put between the grip roller 7a and pinch roller 7b.

The thermal head 5 is pressed onto the platen roller 6 with a driving unit not shown so that the ink sheet 3 is put closely to the recording paper 2. In this state, the driving unit not shown causes the top position of a Y color of the ink sheet 3 to agree with the print start position (the heating element line position of the thermal head 5).

The data dividing unit 10a of the image data converter unit 10 decides as to whether the input image data provides an image not wider than the prescribed picture size or an image wider than the prescribed size. When it is an image not wider than the prescribed picture size, the input image data is stored in the memory 11 as it is, and the data processing unit 12 converts it to print data. Then, the control unit 13 controls the thermal head driving unit 14, paper feed mechanism driving unit 15, recording paper cutting mechanism unit 16 and ink sheet conveyance driving unit 17, thereby carrying out printing operation.

Once the printing operation is started, the grip roller 7a conveys the recording paper 2 to the printing direction (in the direction A of FIG. 1), and at the same time the thermal head 5 starts printing of Y onto the recording paper 2.

At this time, the thermal head driving unit 14 drives the thermal head 5 in accordance with the print data supplied from the data processing unit 12, and the thermal head 5 prints the ink on the ink sheet 3 onto the recording paper 2 line by line. The ink sheet take-up reel 4b winds the printed ink sheet 3.

After printing Y, the thermal head 5 is pulled with the driving unit not shown, and the grip roller 7a conveys the recording paper 2 toward the paper output direction (in the direction B of FIG. 1) up to the print start position. In addition, the ink sheet take-up reel 4b winds the ink sheet 3 that has completed the Y printing as far as the top position of the M color of the ink sheet 3 is aligned with the print start position.

After that, in the same manner as the Y printing operation, the thermal head 5 is pressed on the platen roller 6, the grip roller 7a starts conveying the recording paper 2 in the printing direction (direction A of FIG. 1), and the thermal head 5 starts printing M. After printing M, the operation similar to that after printing Y is carried out : the grip roller 7a conveys the recording paper 2 to the print start position, and the thermal head 5 makes C printing in the same printing operation as that of Y or M printing.

After printing the Y, M and C colors, the thermal head 5 is pulled with the driving unit not shown, and the grip roller 7a conveys the recording paper 2 in the paper output direction (direction B of FIG. 1A). When the top printing position of the recording paper 2 reaches the recording paper cutting mechanism 8 on the conveyance path, the grip roller 7a stops driving, the recording paper cutting mechanism 8 cuts the recording paper 2 in the main scanning direction, and the paper output roller 9 ejects the recording paper 2 to the outside of the printer 1.

As described above, the printing operation of an image not greater than the prescribed picture size is carried out.

Next, the printing operation of an image wider than the prescribed picture size will be described. First, an outline of a processing method of the image data will be described.

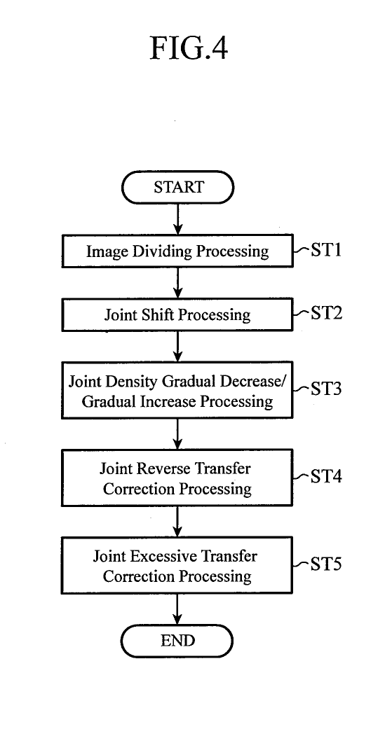

FIG. 4 is a flowchart showing input image data conversion process by the image data converter unit 10 of the embodiment 1. First, the data dividing unit 10a divides the input image data wider than the prescribed picture size at an image division processing step ST1.

The joint shifting unit 10b shifts the divided image data at a joint shift processing step ST2 in such a manner that the joints of the Y, M and C colors are not aligned. After completing the joint shift processing step ST2, the joint processing unit 10c performs processing of making the joints of the Y, M and C colors inconspicuous at a joint density gradual decrease/gradual increase processing step ST3. The joint processing unit 10c carries out reverse transfer correction processing in the joints of the individual colors at a joint reverse transfer correction processing step ST4. Finally, the joint processing unit 10c carries out excessive transfer correction processing in the joints of the individual colors at a joint excessive transfer correction processing step ST5.

Next, details of the individual processing steps ST1-ST4 will be described.

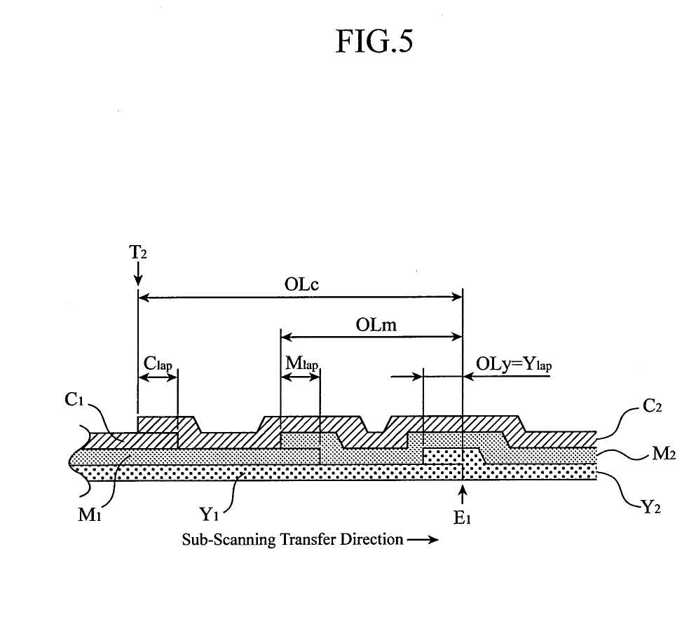

FIG. 5 is a schematic diagram showing an ink transfer state in the joints between pieces of the image in the embodiment 1. The symbol E₁ designates an image record end line position of a first piece, and T₂ designates an image record start line position of a second piece. The symbols OLy, OLm and OLc designate areas in which the Y color, M color and C color of the first piece and second piece overlap. In addition, the symbols Yₗₐₚ Mₗₐₚ and Cₗₐₚ designate areas in which the Y color, M color and C color inks of the second piece are applied on the same color inks of the first piece.

Here, on the assumption that the prescribed picture size of the color ink sheet 3 in the sub-scanning transfer direction is L and the input image size is 2L, an example will be described in which the input image is divided into two pieces and undergoes joint processing. From now on, the operation of printing a plurality of pieces of an image continuously to form a single wide image (picture) is defined as wide printing.

First, the image division processing ST1 will be described.

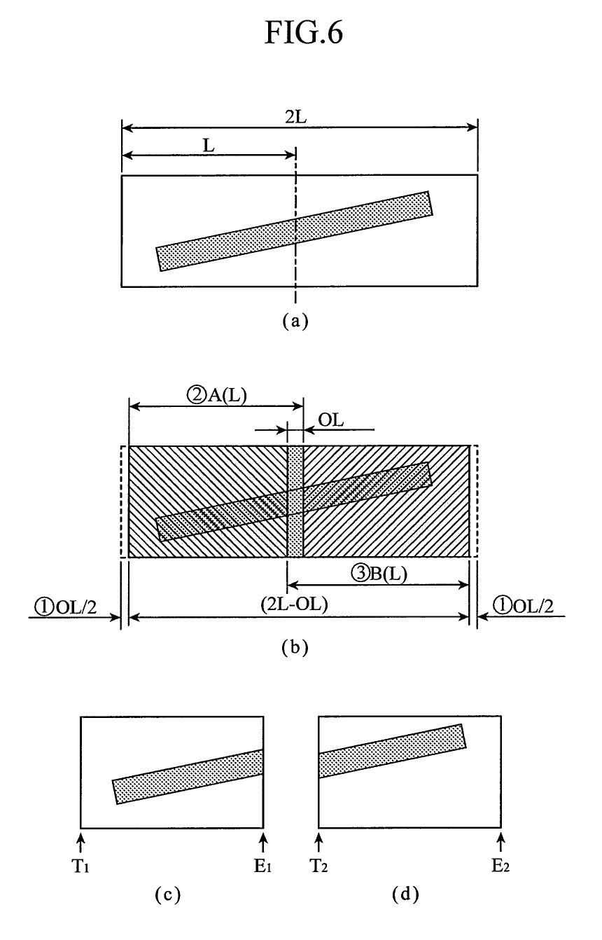

FIG. 6(a) is a diagram showing an input image with an image size in the sub-scanning transfer direction being 2L. FIG. 6(b) is a diagram illustrating a dividing method of the input image data. The symbol OL designates the maximum value of the sub-scanning area where the first piece and the second piece overlap each other, which corresponds to OLc in FIG. 5.

The data dividing unit 10a removes an area of OL/2 from both ends of the input image in the sub-scanning transfer direction, first.

Next, as for the area after removing the OL/2 areas in FIG. 6(b), the data dividing unit 10a makes from its left end an image A with the prescribed picture size L equal to the size of the color ink sheet 3 in the sub-scanning transfer direction, and makes from its right end an image B with the prescribed picture size L equal to the size of the color ink sheet 3 in the sub-scanning transfer direction. In this case, the images A and B form the image data after dividing the input image into two pieces.

FIG. 6(b) is a diagram showing a state in which the divided images A and B are recorded in combination. In this case, as for the size in the sub-scanning transfer direction, it is shorter than the original input image by the overlapping area OL of the images A and B.

FIGS. 6(c) and 6(d) are diagrams showing the divided images A and B, respectively. The record start line position of the first piece is T₁ and its record end line position is E₁. In addition, the record start line position of the second piece is T₂ and its record end line position is E₂

Next, the joint shift processing step ST2 of the Y, M and C colors of the divided images will be described with reference to FIG. 6. First, the joint shifting unit 10b converts the gradation data of red (R), green (G) and blue (B) of the first piece A and second piece B into C, M and Y gradation data. Colors R, G and B and colors C, M and Y are complementary colors and are able to be converted by the following Expressions (1)-(3) where the maximum gradation number is 1.

C=1−R Expression (1)

M=1−G Expression (2)

Y=1−B Expression (3)

The following description will be made under the assumption that the gradation data of the image are C, M and Y gradation data.

Next, the joint shift processing ST2 of the first piece A will be described.

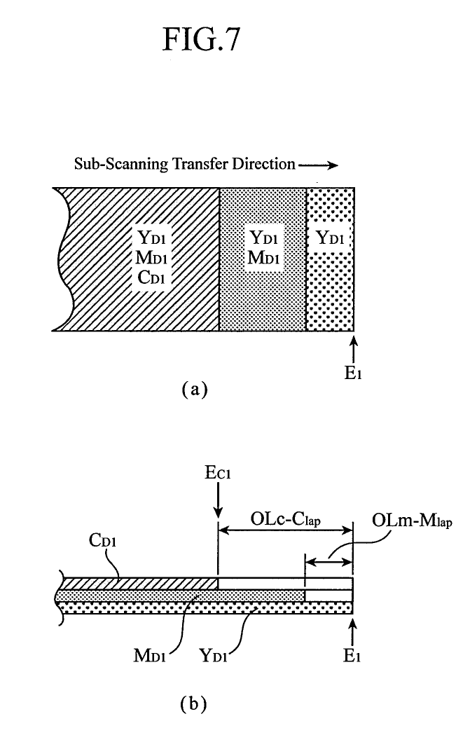

FIG. 7 is a schematic diagram showing the image data with their joints of Y, M and C colors being shifted: FIG. 7(a) is a schematic diagram showing a plane; and FIG. 7(b) is a schematic diagram showing its side view. Symbols Y_{D1}, M_{D1} and C_{D1} designate Y, M and C gradation data of the first piece.

The Y color gradation data Y_{D1} which is recorded first does not undergo any conversion. As for the M color gradation data M_{D1} which is recorded next to the Y color, the joint shifting unit 10b converts the data so as not to transfer the sub-scanning area (OLm−Mₗₐₚ) from the image record end line position E₁ of the first piece. More specifically, it converts the data corresponding to the area so as to become white data.

Finally, as for the C color gradation data C_{D 1} to be recorded also, the joint shifting unit 10b converts the sub-scanning area (OLc−Cₗₐₚ) from the image record end line position of the first piece so as to become white data.

Next, the joint shift processing ST2 of the second piece B will be described.

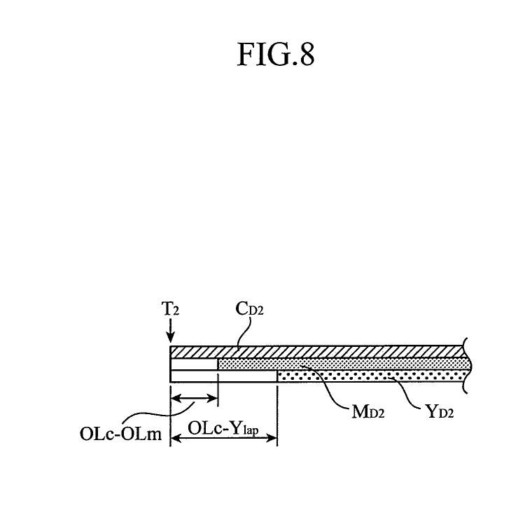

FIG. 8 is a schematic plan view showing the image data with their joints of Y, M and C colors being shifted. Symbols Y_{D2}, M_{D2} and C_{D2} designate Y, M and C gradation data of the second piece.

The joint shifting unit 10b converts the Y color gradation data Y_{D2} which is recorded first so as not to transfer the sub-scanning area (OLc−Yₗₐₚ) from the image record start line position T₂ of the second piece. More specifically, it converts the data corresponding to the area so as to become white data.

As for the M color gradation data M_{D2} to be recorded next to the Y color, the joint shifting unit 10b converts it so as not to transfer the sub-scanning area (OLc−OLm) from the image record start line position T₂ of the second piece. More specifically, it converts the data corresponding to the area to become white data. Finally, as for the C color gradation data C_{D2} to be recorded, it does not undergo any conversion. In this way, the joint shift processing step ST2 terminates.

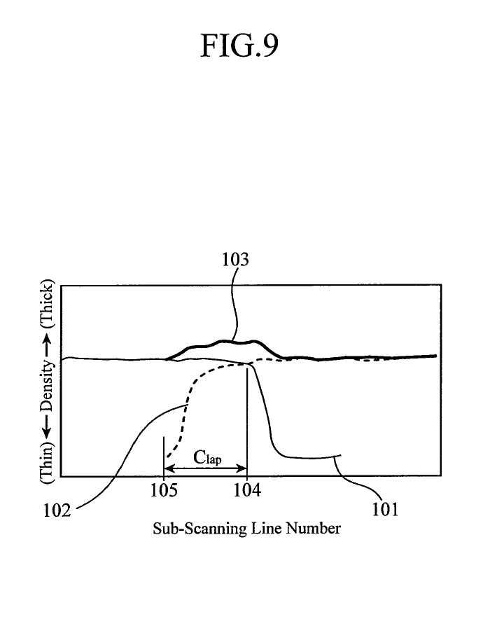

Next, the joint density gradual decrease/gradual increase processing step ST3 will be described with reference to FIG. 9.

FIG. 9 is a diagram showing relationships between the sub-scanning line number and transfer density of any given gradation data of the C color in a joint. A first piece C color single transfer density 101 shows the transfer density when transferring the C color of the first piece alone (without overlap), and a second piece C color single transfer density 102 shows the transfer density when transferring the C color of the second piece alone.

The C color transfer end line position 104 of the first piece corresponds to E_{c1} of FIG. 7(b). The C color transfer start line position 105 of the second piece corresponds to T₂ of FIG. 8. The symbol Cₗₐₚ designates an overlapping line area of the C color, and an overlapping transfer density 103 of the first piece C color and the second piece C color shows the transfer density when the first piece C color and the second piece C color overlap by Cₗₐₚ.

As shown by the first piece C color single transfer density 101 in FIG. 9, the ink is transferred beyond the end line position 104 of the image gradation data at an image edge at the transfer end owing to the thermal hysteresis phenomenon of the sublimation dye transfer printing method. This is a problem due to a heat storage quantity of the thermal head. The longer the high gradation data continues, the more the heat storage quantity of the thermal head, and even if the transfer signal of the thermal head is turned off (the gradation data is made zero), the heat storage of the thermal head causes the ink color to be transferred for a certain line interval.

In addition, at the transfer start portion, since the heat storage of the thermal head is low, the transfer density gradually rises as shown by the second piece C color single transfer density 102, which offers a problem in that the transfer density becomes low at the transfer start portion. Because of the thermal hysteresis phenomenon described above, in particular owing to the phenomenon that the rising density becomes low, simple alignment of the joints between the first piece and second piece does not result in good joint image quality. Accordingly, it is necessary for the transfer end portion of the first piece and the transfer start portion of the second piece to be transferred in an overlap manner.

As is clear from the overlapping transfer density 103 of the first piece C color and the second piece C color, the transfer density becomes high in the simply overlapping portion Cₗₐₚ of the first piece and the second piece. To achieve good joint image quality, it is necessary to control the transfer density 103 in the overlapping portion so as to become equal to the transfer density in front and behind the Cₗₐₚ. The transfer density 103 in the overlapping portion can be controlled so as to be equalized with the transfer density in front and behind the Cₗₐₚ by appropriately adjusting the gradation data in the end portion of the first piece and the gradation data in the start portion of the second piece.

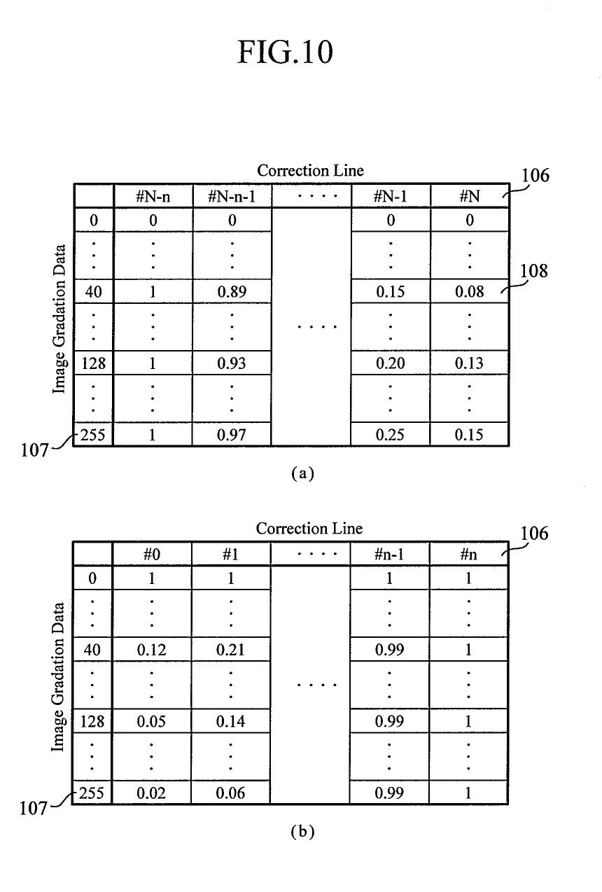

FIG. 10(a) is a diagram showing a C color lookup table (LUT) as a correction table for adjusting the gradation data in the end portion of the first piece, and FIG. 10(b) is a diagram showing a C color LUT for adjusting the gradation data in the start portion of the second piece. A row 106 shows the line number in the sub-scanning transfer direction, and a column 107 shows the gradation data of an input image consisting of 8 bits for each color which gives 0-255 levels.

In FIG. 10(a), the end line position (line number) of the image data of the first piece to be converted is assumed to be N. The symbol #N designates the end line position of the input image data of the first piece after the end of the joint shift processing step ST2, which corresponds to the EC1 of FIG. 7(b) and the end line position 104 of FIG. 9. FIG. 10(a) shows that n line data are adjusted from the input image data end line position #N of the first piece.

In FIG. 10(b), the transfer start line position (line number) of the image data of the second piece after the end of the joint shift processing step ST2 is made #0, and the #0 line position corresponds to the start line position T2 of FIG. 8 and the start line position 105 of FIG. 9. FIG. 10(b) shows that n line data are adjusted from the input image data transfer start line position #0 of the second piece.

Incidentally, although the C color LUT will be described here, since the transfer characteristics generally differ depending on the ink colors, LUTs as shown in FIG. 10 are prepared by the number of colors.

The conversion of the gradation data is achieved by multiplying the input gradation data by a coefficient at an intersection of the line number to be adjusted and the gradation data of an input pixel to be converted in the LUT of FIG. 10(a) or 10(b). For example, in the conversion of the end portion of the first piece, when a pixel to be converted has the line number #N−1 and the gradation data 128, the value 26 obtained by multiplying 128 by the coefficient 0.2 (round off to the nearest whole number) is used as the input gradation data after the input conversion.

The joint processing unit 10c carries out the conversion by n lines. As for the gradation data conversion in the transfer start portion of the second piece, it is also carried out by obtaining the adjusting coefficient from the LUT of FIG. 10(b) from the line number and the gradation data of the pixel to be converted.

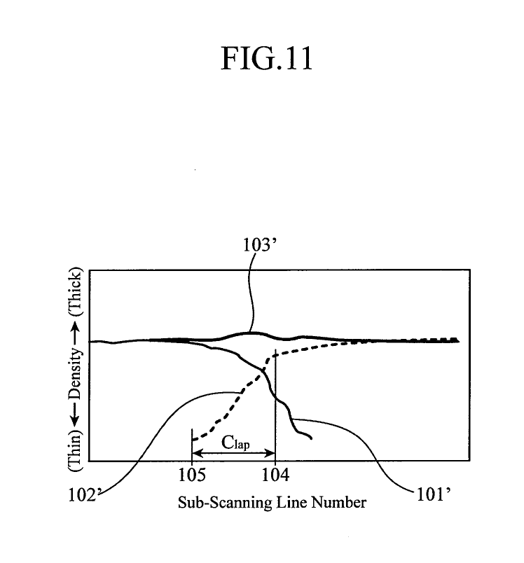

FIG. 11 is a diagram showing density distribution of a joint transfer result after the gradation data conversion.

The single transfer density 101′ after the first piece C color gradation data conversion shows the single transfer density of the first piece C color after the gradation data conversion, and the single transfer density 102′ after the second piece C color gradation data conversion shows the single transfer density of the second piece C color after the gradation data conversion.

Compared with the graph shown in FIG. 9, the single transfer density 101′ of the first piece falls slowly and the single transfer density 102′ of the second piece rises slowly.

The overlapping transfer density 103′ of the first piece C color and the second piece C color after the gradation data conversion shows the transfer density when transferring the first piece C color end portion and the second piece C color transfer start portion after the gradation data conversion by overlapping by the width Cₗₐₚ. It is seen that the transfer density in the width Cₗₐₚ is nearly equal to the transfer density in front and behind the Cₗₐₚ.

In this way, even if the first piece and second piece are transferred in an overlapping manner in the joints between the pieces of the image, the transfer density in the overlapping portion can be equalized to the transfer density in front and behind the Cₗₐₚ by appropriately adjusting the gradation data in the end portion of the first piece and the gradation data in the start portion of the second piece. Although the processing of the C color is described above, as for the M color and Y color, the transfer density in their joints can also be controlled by the same processing as that of the C color using their own LUTs

The LUT in FIG. 10(a) or 10(b) can be formed through the following procedure. As shown in FIG. 9, using the graph of the single transfer densities 101 and 102 and the overlapping transfer density 103, when the overlapping transfer density 103 is higher than the transfer density in front and behind the overlapping portion Cₗₐₚ coefficients in the LUT are adjusted so as to reduce the single transfer densities 101 and 102 in accordance with the line positions. On the contrary, when the overlapping transfer density 103 is lower than the transfer density in front and behind the overlapping portion Cₗₐₚ, coefficients in the LUT are adjusted so as to increase the first piece single transfer density 101 and second piece single transfer density 102 in accordance with the line positions. The LUT is adjusted by actually carrying out and repeating the transfer operation.

Next, the joint reverse transfer correction processing step ST4 will be described. First, the reverse transfer problem in the embodiment 1 will be described. As a result of investigations of the inventors, it is found that the reverse transfer problem described here has mutual relation between the gradation data of the ink color transferred over the existing ink of the first piece and the gradation data of the ink color forming the ground (ink color previously transferred).

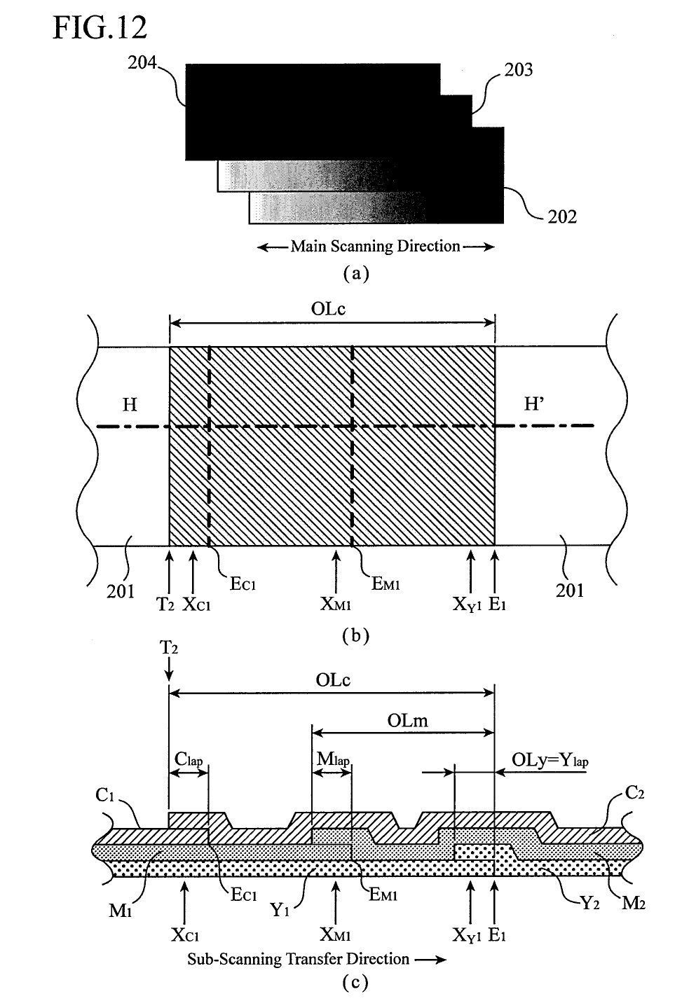

FIG. 12(a) is a diagram schematically showing as to the reverse transfer problem an example of image patterns for explaining mutual relation between the gradation data of an ink color to be transferred over the existing ink of the first piece and the gradation data of the (previously transferred) ink color forming a ground. Inks of the Y color 202 and M color 203 forming the ground have a gradation pattern with its density increasing in the main scanning direction from the left to right of FIG. 12(a), and the C color 204 transferred finally has a solid pattern.

As for a state after applying the joint processing steps ST1-ST3 to the pattern images of the three colors of Y color 202, M color 203 and C color 204, FIG. 12(b) is a schematic plan view showing an ink joint state after making a wide print, and FIG. 12(c) is a schematic side view thereof. Front and rear areas 201 of the joints are an area in front and behind the area in which the inks are transferred over the existing colors, and line positions at which the reverse transfer occurs are line positions in front and behind X_{C1} and X_{M1} of FIGS. 12(b) and 12(c), where X_{C1} designates a line position near the center of the C color overlapping area Cₗₐₚ and X_{M1} designates a line position near the center of the M color overlapping area Mₗₐₚ. The symbol X_{Y1} designates a line position near the center of the Y color overlapping area Yₗₐₚ.

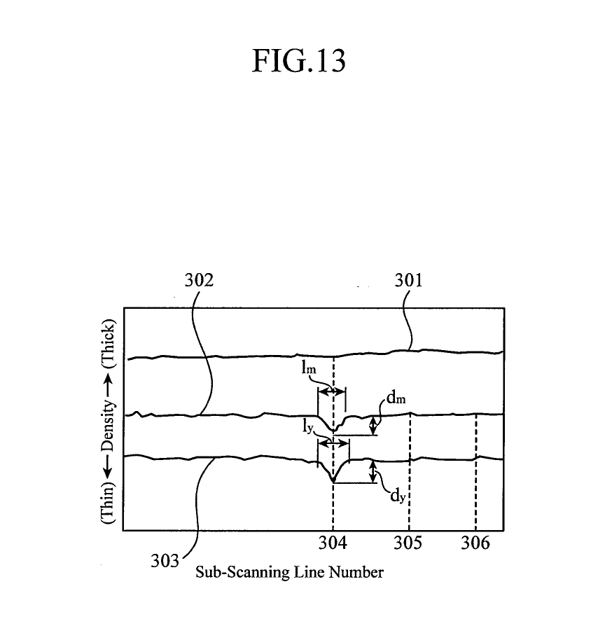

FIG. 13 is a diagram showing density distribution in the sub-scanning transfer direction (in the H-H′ direction of FIG. 12(b)) when the gradation data of the C color 204 has a high density in the patterns of FIG. 12, and a wide print is made.

In FIG. 13, the C color component density 301, M color component density 302 and Y color component density 303 show a component density of each color. The C color joint neighboring line position 304 corresponds to the X_{C1} of FIG. 12(b) or 12(c), the M color joint neighboring line position 305 corresponds to the X_{M1} of FIG. 12(b) or 12(c), and the Y color joint neighboring line position 306 corresponds to the X_{Y1} of FIG. 12(c).

The symbol dₘ designates a density difference between the lowest density of the M color component and the M color component average density in a common transfer area, and d_{y} designates a density difference between the lowest density of the Y color component and the Y color component average density in a common transfer area. The symbol lₘ designates an M color component density reduction line interval in which the density reduction of the M color component occurs, and l_{y} designates a Y color component density reduction line interval in which the density reduction of the Y color component occurs.

Although the C color component density 301 is equal to the transfer density in front and behind the C color joint neighboring line position 304, the M color component density 302 has a density reduction in the line interval lₘ, and the Y color component density 303 has a density reduction in the line interval l_{y}. The C color joint neighboring line position 304 is in a common transfer area of the first piece, where the M color component density and Y color component density are maintained essentially. The density reduction of the M color component density 302 or Y color component density 303 is due to the effect of the joint transfer of the C color, and processing for correcting the density reduction is necessary.

Next, the joint density difference will be described when the gradation data of the C color 204 in the patterns of FIG. 12 is made a high gradation, halftone or low gradation solid pattern, followed by wide printing.

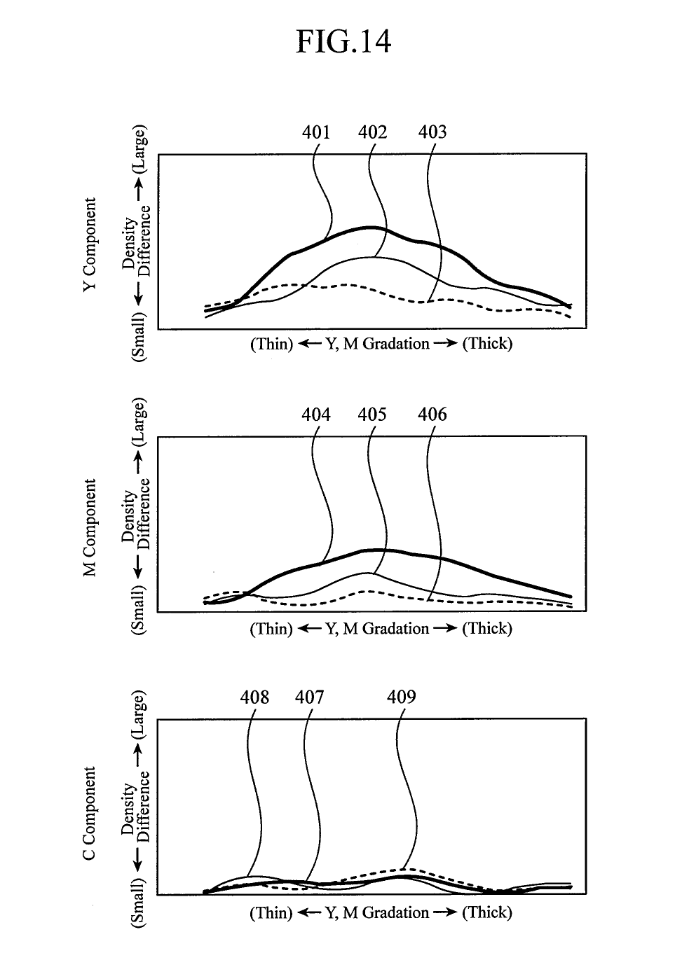

FIG. 14 is a joint density difference graph illustrating density differences of the Y color component, M color component and C color component at the C color joint neighboring line position 304.

In FIG. 14, a horizontal axis shows the gradation data of the Y color and M color as a ground color, and a vertical axis shows the density difference of each color in the C color joint. Incidentally, the term “joint density difference” here refers to an absolute value of the difference (corresponding to dₘ and d_{y} of FIG. 13) between the lowest density near the C color joint neighboring line position 304 and the average transfer density in the front and rear areas 201 of the joints of FIG. 12 when carrying out density distribution analysis as shown in FIG. 13.

The density difference 401 is the density difference of the Y color component in the case of the C color high gradation solid pattern, the density difference 402 is the density difference of the Y color component in the case of the C color halftone solid pattern, and the density difference 403 is the density difference of the Y color component in the case of the C color low gradation solid pattern.

The density difference 404 is the density difference of the M color component in the case of the C color high gradation solid pattern, the density difference 405 is the density difference of the M color component in the case of the C color halftone solid pattern, and the density difference 406 is the density difference of the M color component in the case of the C color low gradation solid pattern.

The density difference 407 is the density difference of the C color component in the case of the C color high gradation solid pattern, the density difference 408 is the density difference of the C color component in the case of the C color halftone solid pattern, and the density difference 409 is the density difference of the C color component in the case of the C color low gradation solid pattern.

It is found from FIG. 14 that the density difference of the C color component (407, 408 and 409 of FIG. 14) is very small independently of the C color gradation. In addition, the density difference is nearly constant.

In contrast with this, as for the Y color component density difference (401, 402 and 403 of FIG. 14) and the M color component density difference (404, 405 and 406 of FIG. 14), it is found that the higher the C color transfer density (gradation data), the greater the density difference. In addition, the density difference becomes maximum when the Y color or M color, which is a ground color, is halftone (near the center of the horizontal axis in the graph of FIG. 14).

Although the foregoing description is made about the reverse transfer problem when the overlapping ink color is the C color, a similar phenomenon occurs at the joint neighboring line position of the M color (X_{M1} of FIG. 12) when the ink color to be superposed is the M color. In the case of the embodiment 1, the ink color forming a ground of the M color is a single color Y, and the transfer density of the Y component color reduces at the joint neighboring line position of the M color (X_{M1} of FIG. 12).

The reducing trend of the transfer density is the same as when the ink color to be superposed on the ink of the first piece is the C color as described above, and the higher the gradation (density) of the M color which is the ink color to be superposed, the greater the density difference of the Y component color at the joint neighboring line position of the M color (X_{M1} of FIG. 12). In addition, when the Y color which is the ground color is halftone (near the center of the horizontal axis of the graph of FIG. 14), the density difference becomes maximum.

As described above, the density difference due to the reverse transfer occurring at the joints varies depending on the gradation data of the ink color to be transferred over the existing colors and the gradation data of the (previously transferred) ink color forming the ground. Accordingly, considering the gradation data, it is necessary to correct the input image data.

In addition, as designated by the symbols 1ₘ and l_{y} of FIG. 13, the joint density difference occurs within a several line interval in front and behind the joint neighboring line position. The density difference within the density difference occurrence line interval varies depending on the line position, and the image quality at the joints can be improved by making correction corresponding to the line position in front and behind the joint neighboring line position.

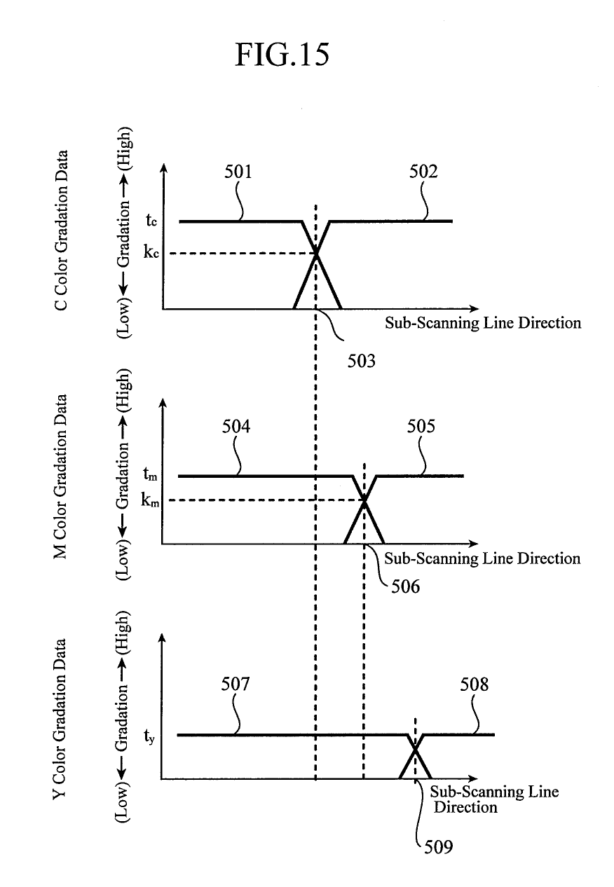

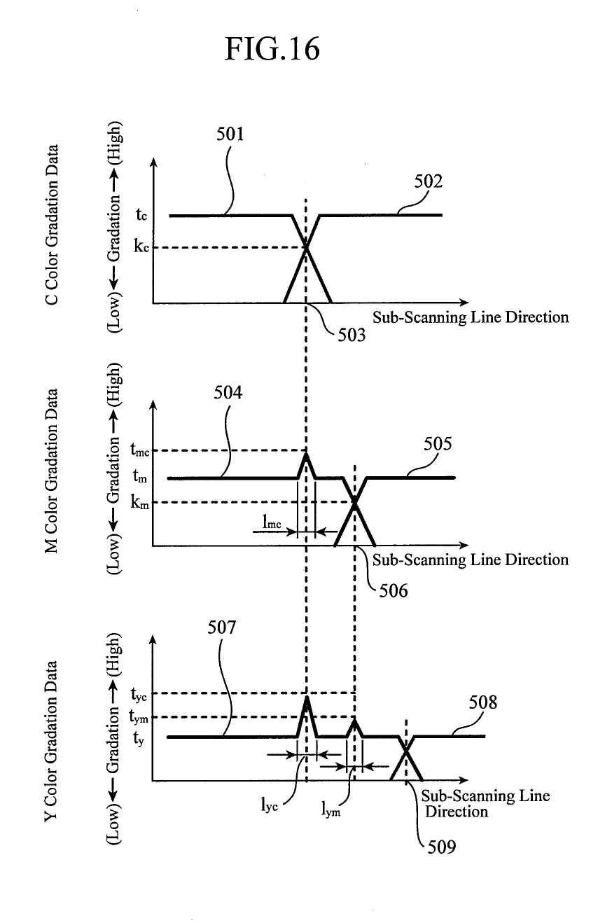

Next, the processing operation of the joint reverse transfer correction processing step ST4 will be described with reference to FIG. 15 and FIG. 16.

FIG. 15 is a schematic diagram showing the Y, M and C gradation data after applying the joint processing steps ST1-ST3 to the image patterns in which the gradation values are constant in the sub-scanning transfer direction for the individual colors.

In FIG. 15, the gradation value t, designates a C color gradation value, the gradation value tₘ designates an M color gradation value, and the gradation value t_{y} designates a Y color gradation value. The graph 501 designates a first piece C color gradation data graph, the graph 502 designates a second piece C color gradation data graph, and the C color joint line position 503 designates the line position at the point of intersection of the graph 501 with the graph 502. The graph 504 designates a first piece M color gradation data graph, the graph 505 designates a second piece M color gradation data graph, and the M color joint line position 506 designates the line position at the point of intersection of the graph 504 with the graph 505.

The graph 507 designates a first piece Y color gradation data graph, the graph 508 designates a second piece Y color gradation data graph, and the Y color joint line position 509 designates the line position at the point of intersection of the graph 507 with the graph 508. The gradation value K_{c} designates a gradation value of C color joint pixels at the C color joint line position 503, and the gradation value Kₘ designates a gradation value of M color joint pixels at the M color joint line position 506.

In a state before the joint reverse transfer correction processing, the M color gradation value and Y color gradation value at the C color joint line position 503 are constant at tₘ and t_{y}, and the Y color gradation value at the M color joint line position 506 is constant at t_{y}.

FIG. 16 is a diagram schematically showing the Y, M and C gradation data when making wide printing after applying the joint processing steps ST1-ST4 to the same image patterns as those of FIG. 15. FIG. 15 shows a state without the joint reverse transfer correction processing, and FIG. 16 shows a state with the joint reverse transfer correction processing.

The gradation value t is the maximum gradation value after correcting the M color at the C color joint line position 503, which is corrected to a gradation number higher than the M color gradation value tₘ. The correction is made for the pixels in the correction line interval l_{mc}.

The gradation value t_{yc} is the maximum gradation value after correcting the Y color at the C color joint line position and the gradation value t_{ym} is the maximum gradation value after correcting the Y color at the M color joint line position 506, which are corrected to a gradation number higher than the Y color gradation value t_{y}, respectively. The correction is made for the pixels in the correction line intervals l_{yc} and l_{mc}.

Next, a calculating method of the foregoing correction gradation number will be described.

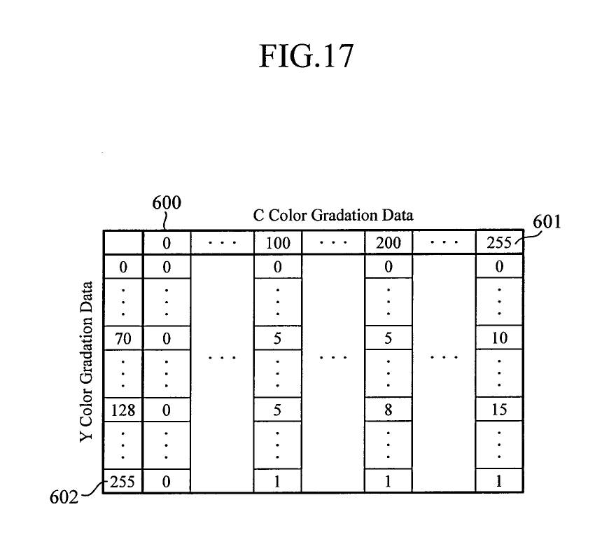

FIG. 17 shows an LUT 600 for acquiring the maximum gradation value t_{yc} after correcting the Y color at the C color joint line position 503. The row 601 shows a gradation value k_{c} of a C color joint pixel, and the column 602 shows a Y color gradation value t_{y} at the C color joint line position 503.

A value in the LUT 600 is a correction gradation number, in which when the gradation value of a C color joint pixel k_{c}=0 and the Y color gradation value t_{y}=0, no conversion is carried out. A concrete correction example will be given here. For example, when the gradation value of the C color joint pixel k_{c}=255 and a Y color gradation value t_{y}=128, the correction is 15. The LUT 600 is formed in such a manner as to have the maximum correction when the Y color gradation value t_{y} is halftone.

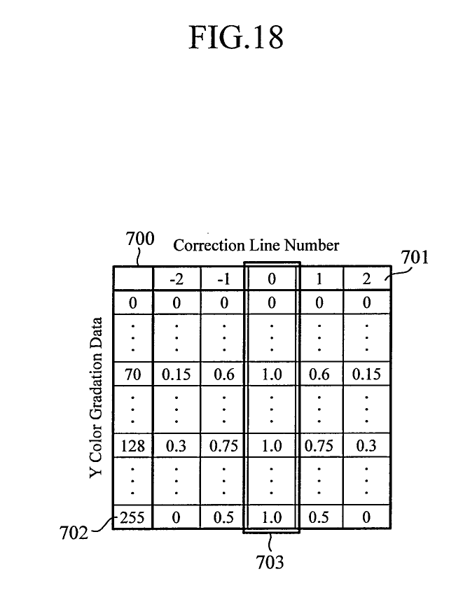

FIG. 18 shows an LUT 700 for acquiring a correction in the correction line interval l_{yc}. The row 701 shows a correction line number, in which the number 0 designates the C color joint line position 503. The LUT 700 has the C color joint line position 503 and two lines in front and behind it, that is, the total five lines in the correction line interval l_{yc}.

The positive numbers in the row 701 designate a downstream side in the sub-scanning transfer direction (closer to the second piece) with respect to the C color joint line position 503, and the negative number designates an upstream side in the sub-scanning transfer direction (closer to the first piece).

The column 702 shows the Y color gradation value t_{y} at the C color joint line position 503. Values in the LUT 700 are correction coefficients, which are set in such a manner that the conversion is not carried out when the Y color gradation value t_{y}=0, and the corrections at the C color joint line position 503 (line number 0) become maximum.

The corrections for the correction line number are calculated by multiplying the correction gradation number acquired from the LUT 600 by the correction coefficient acquired from the LUT 700. For example, when the gradation value of the C color joint pixel k_{c}=255 and the Y color gradation value t_{y}=128 from the LUT 600, the correction gradation number is 15. The correction gradation number is multiplied by the correction coefficients acquired from the LUT 700. The corrections for the correction line numbers −2, −1, 0, 1, 2 are obtained as 15×0.3, 15×0.75, 15×1, 15×0.75, 15×0.3, respectively.

The gradation numbers after the final correction are obtained by adding the correction gradation numbers acquired from the LUT 600 and LUT 700 to the original gradation number. Accordingly, the post-correction gradation numbers of the pixels corresponding to the correction line numbers −2, −1, 0, 1 and 2 in the foregoing case are 133, 139, 143, 139 and 133, respectively.

Although the foregoing description is made about the method of obtaining the post-correction gradation numbers of the Y color at the C color joint line position 503, the post-correction gradation numbers of the M color at the C color joint line position 503 can be obtained in the same manner. In this case, it is necessary to prepare an LUT for acquiring the maximum gradation value t_{mc} after the correction of the Y color at the C color joint line position 503 and an LUT for acquiring corrections in the correction line interval l_{mc}.

In addition, to obtain the post-correction gradation numbers of the Y color at the M color joint line position 506, it is necessary to prepare an LUT for acquiring the maximum gradation value t_{ym} after the correction of the Y color at the M color joint line position 506 and an LUT for acquiring corrections in the correction line interval l_{ym}.

A reason for using LUTs such as the LUT 600 and LUT 700 is that the density difference due to the reverse transfer occurring in the joints as described above varies depending on the gradation data of the ink color to be transferred over the existing inks of the first piece and depending on the gradation data of the (previously transferred) ink colors forming the ground.

An LUT such as the LUT 600 can be created by actually making wide printing and by measuring the density difference at the joints as shown in FIG. 14. In addition, an LUT such as the LUT 700 can be created from the graph as shown in FIG. 13.

In the same manner as the method of obtaining the post-correction gradation numbers of the Y color at the C color joint line position 503, the post-correction gradation numbers of the M color at the C color joint line position 503 and the post-correction gradation numbers of the Y color at the M color joint line position 506 are obtained, followed by converting the C, M and Y gradation data to the R, G and B gradation data according to Expressions (1)-(3) and by terminating the joint reverse transfer correction processing ST4.

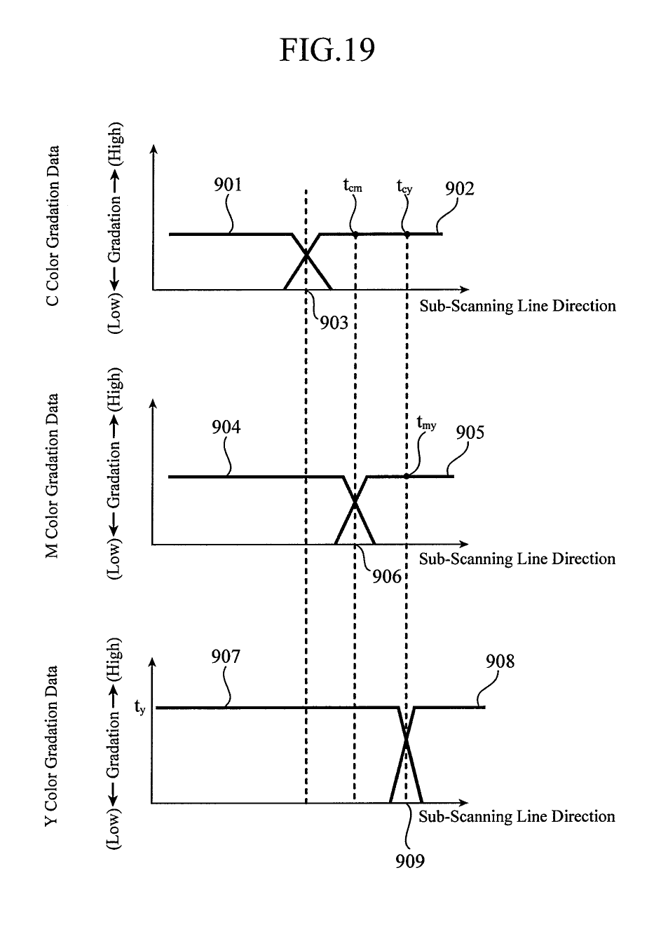

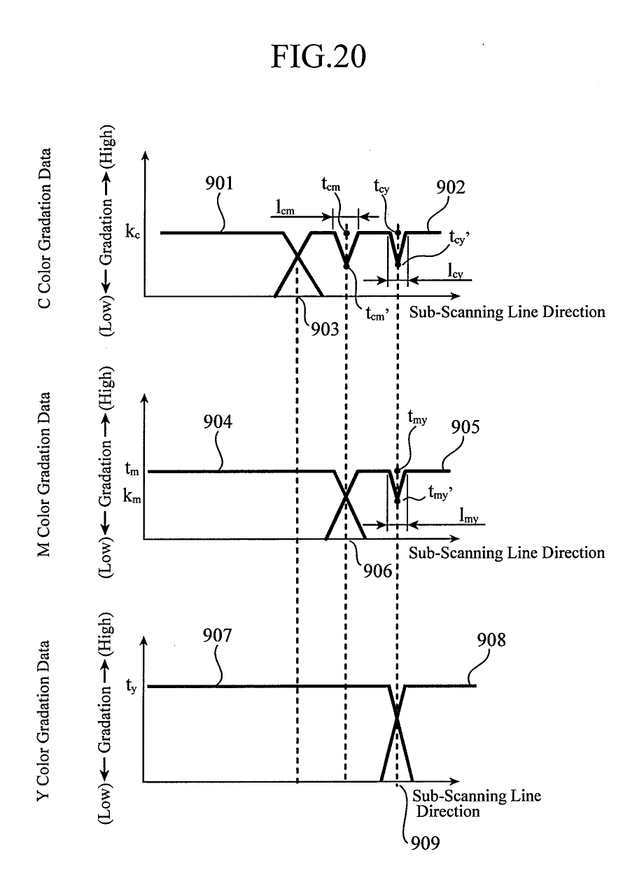

Next, the processing operation of the joint excessive transfer correction processing step ST5 will be described with reference to FIG. 19 and FIG. 20.

FIG. 19 is a schematic diagram showing Y, M and C gradation data after applying the joint processing steps ST1-ST3 to the image patterns in which the gradation values in the sub-scanning transfer direction are constant for the individual colors. Incidentally, to make explanations easier to understand here, a case will be described in which the joint correction processing step ST4 is not carried out.

In FIG. 19, the graph 901 designates a first piece C color gradation data graph, the graph 902 designates a second piece C color gradation data graph, and the C color joint line position 903 designates the line position at the point of intersection of the graph 901 with the graph 902. The graph 904 designates a first piece M color gradation data graph, the graph 905 designates a second piece M color gradation data graph, and the M color joint line position 906 designates the line position at the point of intersection of the graph 904 with the graph 905. The graph 907 designates a first piece Y color gradation data graph, the graph 908 designates a second piece Y color gradation data graph, and the Y color joint line position 909 designates the line position at the point of intersection of the graph 907 with the graph 908.

The gradation value t_{cm} designates the gradation value of the C color at the M color joint line position 906, and the gradation value t_{cy} and gradation value t_{my} designate gradation values of the C color and M color at the Y color joint line position 906, and the gradation value t_{y} designates the Y color gradation value.

FIG. 20 is a diagram schematically showing the Y, M and C gradation data when making wide printing after applying the joint processing steps ST1-ST3 and ST5 to the same image patterns as those of FIG. 19. FIG. 19 shows a state without the joint excessive transfer correction processing, and FIG. 20 shows a state with the joint excessive transfer correction processing.

The gradation value t_{cy}′ is the minimum gradation value after correction of the C color at the Y color joint line position 909, and is corrected to a gradation number lower than the C color gradation value t_{cy}. The correction is performed to the pixels in the correction line interval l_{cy}. The gradation value t_{cm}′ is the minimum gradation value after the correction of the C color at the M color joint line position 906, and is corrected to a gradation number lower than the C color gradation value t_{cm}. The correction is performed to the pixels in the correction line interval l_{cm}. The gradation value t_{my}′ is the minimum gradation value after the correction of the M color at the Y color joint line position 909, and is corrected to a gradation number lower than the M color gradation value t_{m y} . The correction is performed to the pixels in the correction line interval l_{my}.

Next, a calculating method of the foregoing correction gradation numbers will be described.

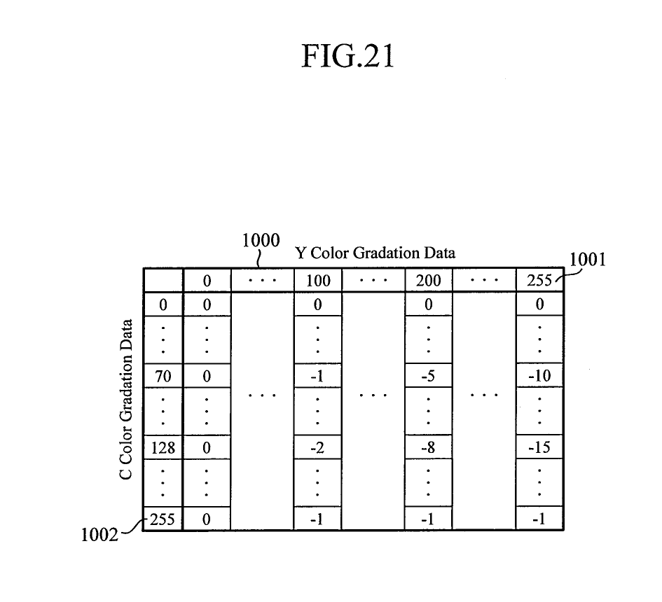

FIG. 21 shows an LUT 1000 for acquiring the minimum gradation value t_{cy}′ after the correction of the C color at the Y color joint line position 909. The row 1001 designates a Y color gradation value t_{y}, and the column 1002 designates a C color gradation value t_{cy} at the Y color joint line position 909.

A value in the LUT 1000 is a correction gradation number, in which when the Y color gradation value t_{y}=0 and C color gradation value t_{cy}=0, no conversion is carried out. A concrete correction example will be given here. For example, when the Y color gradation value t_{y}=255 and C color gradation value t_{cy}=128, the correction is −15 (minus 15). The LUT 1000 is formed in such a manner that the absolute value of the correction becomes maximum when the C color gradation value t_{cy} is halftone.

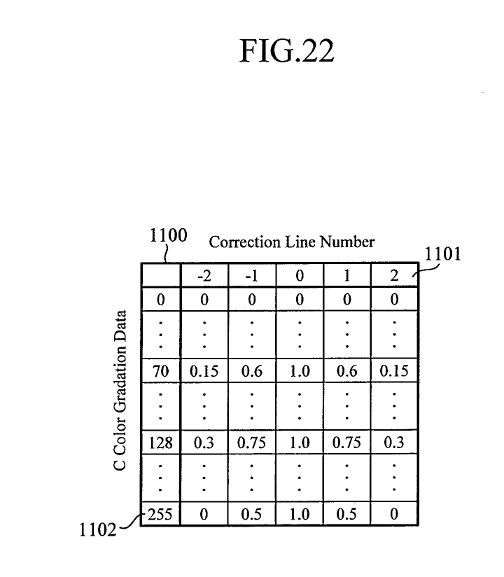

FIG. 22 shows an LUT 1100 for acquiring a correction in the correction line interval l_{cy}. The row 1101 shows a correction line number, in which the number 0 designates the Y color joint line position 909. The LUT 1100 has the Y color joint line position 909 and two lines in front and behind it, that is, the total five lines in the correction line interval l_{cy}.

The positive numbers in the row 1101 designate a downstream side in the sub-scanning transfer direction (closer to the second piece) with respect to the Y color joint line position 909, and the negative number designates an upstream side in the sub-scanning transfer direction (closer to the first piece).

The column 1102 shows the C color gradation value t_{cy} at the Y color joint line position 909. Values in the LUT 1100 are correction coefficients, which are set in such a manner that the conversion is not carried out when the C color gradation value t_{cy}=0, and the absolute values of the corrections at the Y color joint line position 909 (line number 0) become maximum.

The corrections for the correction line number are calculated by multiplying the correction gradation number acquired from the LUT 1000 by the correction coefficient acquired from the LUT 1100. For example, when the gradation value of the Y color joint pixel t_{y}=255 and the C color gradation value t_{cy}=128 from the LUT 1100, the correction gradation number is −15. The correction gradation number is multiplied by the correction coefficients acquired from the LUT 1100. The corrections for the correction line numbers −2, −1, 0, 1, 2 are obtained as (−15)×0.3, (−15)×0.75, (−15)×1, (−15)×0.75, (−15)×0.3, respectively.

The gradation numbers after the final correction are obtained by adding the correction gradation numbers acquired from the LUT 1000 and LUT 1100 to the original gradation number. Accordingly, the post-correction gradation numbers of the pixels corresponding to the correction line numbers −2, −1, 0, 1 and 2 in the foregoing case are 124, 118, 113, 118 and 124, respectively.

Although the foregoing description is made about the method of obtaining the post-correction gradation numbers of the C color at the Y color joint line position 909, the post-correction gradation numbers of the M color at the Y color joint line position 909 can be obtained in the same manner. In this case, it is necessary to prepare an LUT for acquiring the minimum gradation value t_{my}′ after the correction of the M color at the Y color joint line position 909 and an LUT for acquiring corrections in the correction line interval l_{my}.

In addition, to obtain the post-correction gradation numbers of the C color at the M color joint line position 906, it is necessary to prepare an LUT for acquiring the minimum gradation value t_{cm} after the correction of the C color at the M color joint line position 906 and an LUT for acquiring corrections in the correction line interval l_{cm}.

A reason for using LUTs such as the LUT 1000 and LUT 1100 is that the density difference due to the reverse transfer occurring in the joints as described above varies depending on the gradation data of the ink color to be transferred over the existing inks of the first piece and depending on the gradation data of the (previously transferred) ink colors forming the ground.

An LUT such as the LUT 1000 can be created by actually making wide printing and by measuring the density difference. In addition, an LUT such as the LUT 1100 can be created by forming a graph as shown in FIG. 13 as to the excessive transfer state, followed by forming the LUT from the graph.

In the same manner as the method of obtaining the post-correction gradation numbers of the C color at the Y color joint line position 909, the post-correction gradation numbers of the M color at the Y color joint line position 909 and the post-correction gradation numbers of the C color at the M color joint line position 906 are obtained, followed by converting the C, M and Y gradation data to the R, G and B gradation data according to Expressions (1)-(3), and thus the joint excessive transfer correction processing ST5 is terminated, that is, the image data conversion for the wide printing ends.

Incidentally, although the present embodiment is described by way of example that executes the joint excessive transfer correction processing ST5 after applying the joint processing steps ST1-ST3, it is also possible to execute the joint excessive transfer correction processing ST5 after performing the joint processing steps ST1-ST4. In addition, the joint correction processing step ST4 and joint excessive transfer correction processing ST5 are interchangeable, offering the same advantages.

In addition, although the present embodiment is described by way of example in which the image patterns are a solid pattern with uniform gradation data in the sub-scanning direction, as for an image pattern whose gradation data does not vary extremely in joints within several lines in the sub-scanning transfer direction such as a natural picture pattern with comparatively high redundancy, correction processing similar to that of the present embodiment will enable good image quality without any visible joints.

Next, the wide printing operation after the image data conversion will be described.

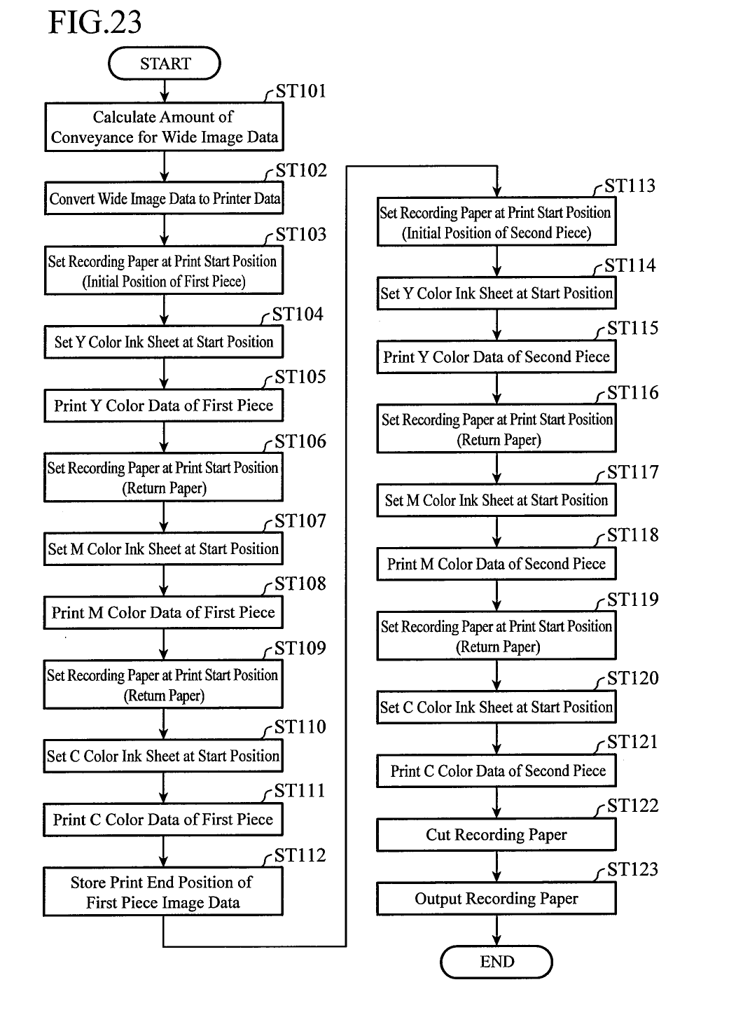

FIG. 23 is a flowchart illustrating the wide printing operation in the present embodiment.

As for the image data divided into two pieces for wide printing by the data dividing unit 10a, the memory 11 stores it, and the control unit 13 calculates the amount of conveyance necessary for the printing from the image data size and the overlapping sub-scanning area of the first piece with the second piece (OL in FIG. 6(b)) (ST101). Next, the image data for the wide printing is converted to printer data (ST102).

In the first piece printing stage, the grip roller 7a sets the recording paper 2 at the print start position first (ST103), and locates the start of a Y color area Y1 of the ink sheet 3 (ST104). Then the thermal head 5 makes printing of the Y color data of the first piece (ST105). After completing the printing of the Y color, the grip roller 7a sets the recording paper 2 at the print start position again (ST106), and locates the start of the M color area M1 of the ink sheet 3 (ST107). Then the thermal head 5 overprints the M color data of the first piece on the Y color (ST108).

After completing the printing of the M color, the grip roller 7a sets the recording paper 2 at the print start position again (ST109) and locates the start of the C color area C1 of the ink sheet 3 (ST110), followed by overprinting the C color data of the first piece on the Y color and M color (ST111). After completing the printing of the C color, the print end position is stored in the memory 11 (ST112).

In the second piece printing stage, first, at the print end position of the image (E1 in FIG. 6(c)) in the first piece printing stage and at the print start position (T2 in FIG. 6(d)) in the second piece printing stage, the recording paper 2 is set so that the position where the first piece and second piece overlap each other in the sub-scanning area (OL in FIG. 6(b)) becomes the print start position of the second piece, and the printing of the second piece is started. As for a series of the printing operation of the second piece (ST113-ST121), since it is the same as the printing stage of the first piece (ST103-ST111), its description will be omitted.

When the printing operation of the second piece terminates, the grip roller 7a conveys the recording paper 2 in the paper output direction (in the direction B of FIG. 1). When the top printing position of the recording paper 2 reaches the recording paper cutting mechanism 8 on the conveyance route, the grip roller 7a stops driving, the recording paper cutting mechanism 8 cuts the recording paper 2 in the main scanning direction (ST122), and the paper output roller 9 ejects the recording paper 2 from the printer 1 (ST123).

As a result of the foregoing operation, a wide printing result with inconspicuous joints is obtained because the joints of the three colors Y, M and C are shifted.

In addition, in the first piece of the image which is printed previously, since the joints of the individual colors are shifted so that the ink colors transferred formerly extend in the sub-scanning transfer direction, even if the second piece is transferred over the existing colors, the transfer sequence of the inks in the joints is unchanged. Accordingly, good joint image quality is achieved without color tone changes in the joints.

In addition, since the correction processing is performed for the reverse transfer that can occur in the shifted joints, a wide printing result with good joint image quality is obtained.

In addition, broadening the intervals between the Yₗₐₚ and Mₗₐₚ and between the Mₗₐₚ and Cₗₐₚ of FIG. 5, that is, broadening the intervals between the joints of the individual colors in the sub-scanning transfer direction offers an advantage of being able to scatter the joints and to make the joints inconspicuous visually.

Incidentally, as for the image converter unit 10 of the embodiment 1, it can be installed within an image input device such as a computer for inputting the image data to the printer 1. In this case, the functions of the image converter unit 10 can be achieved by installing software in the driver for the printer 1.

In addition, although the embodiment 1 employs the density gradual decrease/gradual increase processing as the joint density processing between pieces of an image, when good joint image quality cannot be achieved only by the processing, after applying the density gradual decrease/gradual increase processing, applying image processing based on dithering to the joints between pieces of the image enables scattering the density difference in the joints, thereby being able to improve the joint image quality.

### Embodiment 2

Although the foregoing embodiment 1 employs an ink sheet having three color ink areas of Y, M and C arranged thereon, the present embodiment 2, which will be described below, uses an ink sheet with four ink areas for forming each picture by adding an overcoat layer working as a guard layer to the three color inks of the Y, M and C.

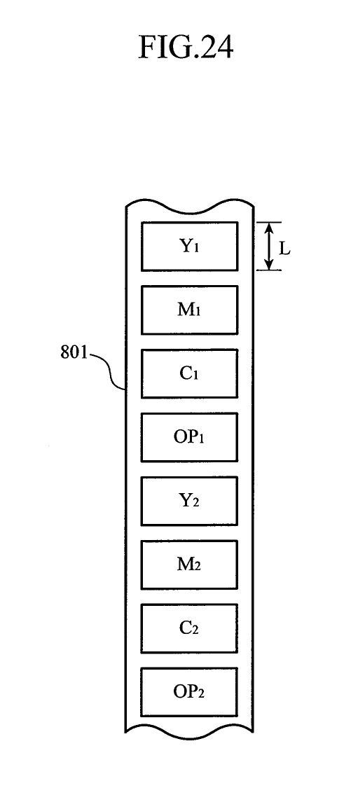

FIG. 24 is a plan view showing an ink sheet 3 in the embodiment 2. The ink sheet 3 has three color ink areas and an overcoat area arranged thereon.

In FIG. 24, symbols Y₁ and Y₂ designate a yellow ink area, M₁ and M₂ designate a magenta ink area, C₁ and C₂ designate a cyan ink area, OP₁ and OP₂ designate an overcoat ink area and L designates a prescribed picture size in the sub-scanning transfer direction. In addition, Y₁, M₁, C₁ and OP₁ designate individual color ink areas of the first piece, and Y₂, M₂, C₂ and OP₂ designate individual color ink areas of the second piece.

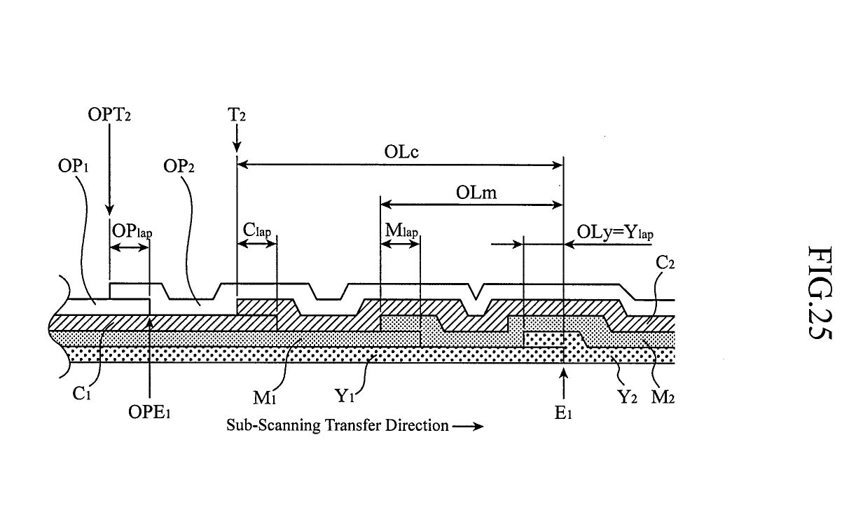

FIG. 25 is a schematic diagram showing an ink transfer state in a joint between pieces of the image in the present embodiment 2. The symbol OP₁ designates the overcoat ink of the first piece, OP₂ designates the overcoat ink of the second piece, OPE₁ designates the transfer end line position of the overcoat ink OP₁ of the first piece, OPT₂ designates the transfer start position of the overcoat ink OP₂ of the second piece, and OPₗₐₚ designates an area where the overcoat ink of the first piece overlaps that of the second piece. Since the remaining ink transfer state is basically the same as that of FIG. 5, the description thereof will be omitted here.

The present embodiment 2 is characterized by that the position where the overcoat ink overlaps each other is set on the first piece side with respect to the image record start line position T₂ of the second piece.

As for common overcoat ink, considering its role as a guard layer of a color ink transfer surface, it is transferred so as to cover all the picture. Thus, in the case of the first piece, after completing color ink transfer of three colors of Y₁, M₁ and C₁, the layer OP₁ is usually transferred so as to cover to the position E₁ of FIG. 25.

However, the sublimation dye transfer printing method records an image by thermal diffusion of sublimation dye to the reception layer of recording paper. Therefore covering the reception layer of recording paper with overcoat ink causes a problem of disabling transfer of sublimation color ink over it. In contrast with this, the embodiment 2 sets the position where the overcoat ink is transferred over the existing colors at the first piece side with respect to the image record start line position T₂ of the second piece. This enables all the joint areas of the wide print image to be covered with the overcoat ink.

### INDUSTRIAL APPLICABILITY

A thermal transfer printer in accordance with the present invention can make a wide print while making its joints inconspicuous. Accordingly, it is suitable for applications such as wide printing on paper with a size greater than a prescribed size.

What is claimed is:

1. A thermal transfer printer for printing a color picture after dividing the color picture into pieces with a prescribed size, the thermal transfer printer comprising:
a joint shifting unit for shifting a joint of each color between the divided pieces so that joints of individual colors are not aligned with each other in a sub-scanning transfer direction; and
a joint processing unit for transferring the joints of the individual colors, which are shifted by the joint shifting unit, so that the joints overlap each other, and for correcting gradation data in an overlapping portion according to correction coefficients that are set in advance for each line in the sub-scanning transfer direction.

2. The thermal transfer printer according to claim 1, further comprising:
a correction table for storing gradation data of pixels in the joint of a color to be transferred subsequently over an existing color, and correction gradation data corresponding to gradation data of pixels of a color to be transferred previously, which pixels correspond to line positions in the joint in the sub-scanning transfer direction, wherein
the joint processing unit decides corrections of the pixels of the color to be transferred previously at the line positions in the joint of the color to be transferred subsequently over the existing color in the sub-scanning transfer direction according to the correction gradation data in the correction table and according to the correction coefficients.

3. The thermal transfer printer according to claim 1, further comprising:
a correction table for storing gradation data of pixels in the joint of a color to be transferred previously, and correction gradation data corresponding to gradation data of pixels of a color to be transferred subsequently over an existing color, which pixels correspond to line positions in the joint in the sub-scanning transfer direction, wherein
the joint processing unit decides corrections of the pixels of the color to be transferred subsequently over the existing color at the line positions in the joint of the color to be transferred previously in the sub-scanning transfer direction according to the correction gradation data in the correction table and according to the correction coefficients.

4. The thermal transfer printer according to claim 1, wherein
the joint shifting unit shifts, at an end portion of a piece of the image, the joint of each color so that each color to be printed previously extends further in the sub-scanning transfer direction than a color to be transferred subsequently.

5. The thermal transfer printer according to claim 1, wherein
the joint processing unit corrects, in the overlapping portion of the colors, the gradation data in the overlapping portion by dithering.

6. The thermal transfer printer according to claim 1, wherein
as for the extent of overcoat layers in their end portions in the sub-scanning transfer direction, which overcoat layers function as a guard layer of the individual colors, the joint shifting unit shifts a joint of the overcoat layers so that the extent of the overcoat layers is less than the extent of a finally transferred color in the sub-scanning transfer direction in the end portions; and
the joint processing unit transfers the joint of overcoat layers, which is shifted by the joint shifting unit, so that the overcoat layers overlap.
